(19) United States
(12) Patent Application Publication
(10) Pub. No.: US 2008/0057158 A1
(43) Pub. Date: Mar. 6, 2008

(54) LACTASE-CONTAINING COMESTIBLES AND RELATED METHODS

(76) Inventors: Steven J. Catani, Athens, GA (US); Kimberly F. Yocum, Furlong, PA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/850,088

(22) Filed: Sep. 5, 2007

Related U.S. Application Data
(60) Provisional application No. 60/824,505, filed on Sep. 5, 2006.

(51) Int. Cl. A23C 9/12

(52) U.S. Cl. 426/42; 426/63

(57) ABSTRACT

The present invention is directed to a non-lactose containing food product treated with lactase.

### CROSS REFERENCE TO RELATED APPLICATIONS

This application claims the benefit of U.S. Provisional Patent Application Ser. No. 60/824,505, filed Sep. 5, 2006, which is incorporated by reference in its entirety.

### FIELD OF THE INVENTION

The present invention is directed to a food product that is treated with a lactose cleaving enzyme, wherein the lactose cleaving enzyme is incorporated in or applied to the food product. The resulting food product may be useful for treating or controlling lactose intolerance in humans in need thereof.

### BACKGROUND OF THE INVENTION

Lactose intolerance is a condition that affects about 75 percent of the world's population. The condition is particularly prevalent among certain ethnic and racial populations. It is estimated to affect as many as 50 percent of Hispanics, 80 percent of African Americans, and 90 percent of Asian Americans.

Lactose intolerance develops when the body has difficulty digesting lactose containing products, such as dairy products. The inability to hydrolyze lactose into its component sugars often results in bloating, cramping, gastrointestinal discomfort, diarrhea, nausea, or flatulence after the ingestion of lactose-containing comestibles in persons having lactose intolerance. In severe cases, malabsorption resulting from lactose intolerance may result in anorexia and weight loss.

Dairy products are generally defined as foodstuffs produced from milk. They are usually high-energy-yielding food products. Dairy products are commonly found in European, Middle Eastern and Indian cuisine, whereas they are almost unknown in East Asian cuisine.

Enzymes have long been known to aid in the digestion of comestibles, e.g., plant and meat, in mammals. Some mammals, particularly humans, lack effective amounts of enzymes to digest various comestibles.

Some humans are considered lactose intolerant because their bodies do not produce an effective amount of β-galactosidase, i.e, lactase, to convert lactose, a disaccharide carbohydrate found in milk produced by various animals, into glucose and galactose. Lactose is a milk sugar and like most sugars, it is broken down by enzymes in the intestinal tract so it can be absorbed as an energy source. The enzyme that breaks down lactose is called lactase. When the intestine does not contain lactase, then lactose intolerance can occur.

People use various methods to obtain relief from the symptoms of lactose intolerance. One such method is in ingesting lactose-reduced or lactose-free fluid dairy products. Such products are currently commercially available in the United States. Another method is ingesting a solid oral dosage form containing an effective amount of fungal- or yeast-derived lactases immediately before ingesting lactose-containing comestibles. Such a solid dosage form is described, for example, in U.S. Pat. No. 3,627,583.

More recently, U.S. Pat. No. 6,833,260 purports to disclose a method of achieving enhanced lactose hydrolysis using lactic acid bacteria that allegedly produces high levels of β-galactosidase, permeablizing the bacteria such that lactose can enter the cell and be hydrolyzed by the highly concentrated β-galactosidase contained therein. The permeabilized lactic acid bacteria purportedly contain high concentrations of β-galactosidase and are referred to as lactase microcarriers. The timing of administering the lactase microcarriers can be before, or with, a dairy meal.

The form of administering the microcarriers can be alone or in a mixture, e.g., in the presence of a pharmaceutically acceptable excipient or carrier (e.g., physiological saline) or into or onto a food product. The food product need not be a dairy food product, but can be a food product that is ingested in conjunction with a dairy food product. For example, the microcarriers can be coated onto a cereal product or included in a chocolate powder for use in milk, coated onto an ice cream cone, or combined with an ice cream bar coating. The lactase microcarriers can also be added to a liquid containing lactose (e.g., a dairy product) in an amount suitable to hydrolyze the lactose so as to generate a lactose free or lactose-reduced liquid.

However, such lactase microcarriers do not make lactase immediately available for hydrolysis. Instead, lactose must enter the bacteria itself before being exposed to lactase. Compositions and methods that provide a lactose cleaving enzyme to a comestible without needing the bacteria to be present would be desirable.

### SUMMARY OF THE INVENTION

The present invention is directed to a non-lactose containing food product treated with a lactose cleaving enzyme.

In one embodiment, the present invention is directed to a food product comprising a lactose cleaving enzyme treated product and a lactose-containing product.

The present invention also includes a method of ameliorating the symptoms of lactose intolerance in an individual who suffers from lactose intolerance, comprising the steps of (a) providing a lactose cleaving enzyme treated non-lactose containing product; and (b) consuming concomitantly the lactose cleaving enzyme treated non-lactose containing product with a lactose containing product.

### DETAILED DESCRIPTION OF THE INVENTION

As used herein, the term “food product” is understood to mean a product that is consumed as food and is not intended to include supplements.

As used herein, the term “substantially” is understood to mean greater than about 50%.

As used herein, the phrase “an effective amount” is understood to mean a sufficient amount of a compound or composition that will positively modify the symptoms and/or condition to be treated, with the proviso that the amount is low enough to avoid serious side effects. The amount of the compound, e.g., β-galactosidase, that is considered safe and effective, will depend upon several factors. For example, one should consider the condition and severity of the condition being treated, the age, body weight, general health, sex, diet, physical condition of the individual being treated, and any other relevant factors.

As used herein, the term “cereal” is understood to mean a ready-to-eat, dry, commercially processed food for human consumption made from one or more grains including, for example, wheat, rice, rye, corn, barley, oats, flax, millet, buckwheat, spelt, quinoa, and amaranth, and/or other ingredients, for example soy, typically consumed with fluid milk.

As used herein, the term “milk” is understood to mean an emulsion of butterfat globules within a water-based fluid. Each fat globule is surrounded by a membrane consisting of phospholipids and proteins. The carbohydrate lactose gives milk its sweet taste. Lactose is a composite of two simple sugars, glucose and galactose. Milk is commonly an opaque white liquid produced by the mammary glands of female mammals. The milk, may undergo homogenization, pasteurization, or other treatment. The exact components of raw milk varies by species, but it contains significant amounts of saturated fat, protein and calcium as well as vitamin C. The term milk is also used for whitish non-animal substitutes such as soy milk, rice milk, almond milk, and coconut milk.

As used herein, the term “non-lactose containing” is understood to mean a food product that has less than about 1 weight percent (wt %) lactose based on the total weight of the food product.

As used herein, the term “serving size” is understood to mean the accepted serving size for a food product as defined in the U.S. Code of Federal Regulations. In one embodiment, a serving size is from about 1 g to about 500 g. In another embodiment, a serving size is from about 5 g to about 300 g. More preferably, from about 10 g to about 250 g. Even more preferably, about 20 g to about 100 g. Still even more preferably, about 30 g to about 60 g.

The food products of the present invention are directed to non-lactose containing food products treated with a lactose cleaving enzyme. The inventive food products are useful in assisting in the amelioration of the symptoms of lactose intolerance caused by the consumption of a lactose containing product.

The manner or method in which the lactose cleaving enzyme is incorporated in or on the food product does not matter, so long as the lactose cleaving enzyme maintains its efficacy. The lactose cleaving enzyme may be added and mixed with other ingredients in the food product. Alternatively, the lactose cleaving enzyme may be applied onto the food product as a coating.

For example, in a Graham Cracker pie crust, an active lactose cleaving enzyme can be introduced as a component in either a water or shortening carrier in the mixture containing graham cracker crumbs, shortening and water, or as a component of the shortening carrier in the mixture containing graham cracker crumbs and shortening. The mixture is distributed onto and compressed into individual plates.

When applied as a coating, application may be accomplished using any suitable means, such as, for example, dipping, spraying, depositing, spray drying, or any other processing techniques.

In one embodiment, the coating composition substantially surrounds the food product.

In another embodiment, the coating composition is applied to at least one surface of the food product.

For example, in a process for making tortilla chips, taco shells, and similar products, tortilla chip dough is sheeted flat and shaped by molds into separate pieces and then baked or fried to a rigid state and subsequently dried to reduce moisture content. A lactase enzyme in solution is sprayed onto the baked or fried chips and dried. The lactase applied is about 6000-9000 FCC units per serving.

The lactose cleaving enzyme may also be applied where a mold blower is employed to evacuate shaped pieces from the molds. Here the lactose cleaving enzyme solution may be incorporated into the mold blower as an adjunct to the air force. This method may be used for shaped chips.

Seasonings such as salt or flavorings may be added after the initial baking or frying process, a lactose cleaving enzyme may be added in powdered, free-flowing form during the seasoning stage and prior to the final heating process, allowing the enzyme to adhere by virtue of the residual heat from the initial frying or baking step. This method is suitable for chips sliced from the sheeted dough and where application of the enzyme is less precise than with molded masa foodstuffs.

The food product is treated with at least about 100 FCC lactase units based on an accepted serving size of the food product. Preferably, the food product is treated with at least about 500 FCC lactase units, and more preferably, at least about 1000 FCC lactase units based on an accepted serving size of the food product.

The lactose cleaving enzyme is capable of hydrolyzing lactose into its two simple sugars, glucose and galactose.

Lactose hydrolyzing lactase enzymes, e.g., lactase and β-galactosidase, are known to be produced by various yeasts, bacteria and fungi. Among the organisms heretofore disclosed as useful for this purpose are yeasts, such as, Saccharomyces fragilis, Torula cremoris and Torula utilis, bacteria, such as, Escherichia coli and Lactobacillus bulgaricus, fungi, such as, Aspergillus oryzae, Aspergillus flavus and Aspergillus niger, and various other microorganisms, such as, those described in U.S. Pat. Nos. 2,681,858; 2,781,266; and 2,809,113. The lactase enzyme preparations produced by these organisms generally have pH optimums on the alkaline side or in the weakly acid pH range of about 5-7. Yeasts, which are the primary source of commercial lactases, are known to produce lactases having pH optimums of about 7.

Suitable lactose cleaving enzymes include but are not limited to, isolated and purified lactase, such as lactase isolated and purified from Saccharomyces lactis, by Gist-Brocade in Delft, Holland, and sold by Enzyme Development Corporation, New York, N.Y.; a lactase from Aspergillus oryzae, Lactase Y-400, produced by K. K. Yakult Honsha; a lactase from Aspergillus oryzae, Plexazym LA 1, produced by Roehm GmbH; a lactase from Aspergillus oryzae, produced by Shinnihon Kagaku Kogyo Co.; a lactase from Kluyveromyces fragilis, produced by Sturges Enzymes, Selby, North Yorkshire, England; a lactase from Aspergillus oryzae, Takamine lactase, produced by Miles Laboratories, Inc., Elkhart, Ind.; Amano Enzyme USA Co. Ltd., Elgin, Ill. as AMANOF100 concentrate, and a lactase from Kluyveromyces fragilis produced by Novo Enzymes, Bagsvaerd, Denmark.

These suppliers and others offer, generally, β-galactosidase (lactase) compositions, including a diluent, having a potency of between 14,000 and 100,000 FCC lactase units/gram.

An acid stable enzyme in powdered form produced by Amano Pharmaceutical Co., Ltd. added to cereal products post-production via liquid or lipid media. The Aspergillus oryzae enzyme from Amano is preferred based on its demonstrated stability in food products.

Additional compositions useful in the present invention include the combination of any lactose cleaving enzyme treated product, e.g., lactase coated ice cream cone, and any lactose containing product, e.g., ice cream.

The lactose cleaving enzyme can be coated onto a comestible by any method known to one skilled in the art, including, spraying, dipping, and dusting. In addition, lactose cleaving enzyme may be incorporated into the comestible by co-extruding or any other method known to one skilled in the art.

Ideally, the lactose cleaving enzyme coated comestible of the present invention should contain sufficient lactase to satisfy the dosage requirement of most individuals requiring the dietary supplement of lactase in most situations. The range of lactase-coated cereal contained in a serving might contain from 2000 FCC lactase units/serving which would be suitable for up to one-half cup milk to 9000 FCC lactase units/serving which would be suitable for up to 2 cups of milk. One-half cup milk is the generally indicated amount per serving of cereal which is one cup.

At least about 100 FCC lactase units, preferably 500 FCC lactase units, more preferably 1000 FCC lactase units are in or applied to the food product based on the serving size of the food product. In one embodiment, the lactose cleaving enzyme is present in about 1000 to about 25000 FCC lactase units, more preferably, about 1000 to about 15000 FCC lactase units, even more preferably, about 1500 to about 10000 FCC lactase units, still even more preferably, about 2000 to about 9000 FCC lactase units, and most preferably, about 2500 to about 6000 FCC lactase units per serving. Serving size varies depending on the food product and is based upon the guidelines provide in the U.S. Code of Federal Regulations.

In one embodiment, freeze drying or flash drying is used to remove water from solution.

The food product may be any non-lactose containing food product. For example, the food product may be a grain product, snack product, vegetable product, fruit product, confectionery product, meat product, seafood product, dessert product, beverage product, condiment, and the like.

Suitable grain products include, for example, cereal, bread, biscuits, cakes, grain bars, pasta, rice, and the like.

Non-lactose containing snack products include, for example, chips, popcorn, crackers, and the like.

Fruit and vegetables, such as berries, nuts, potatoes, broccoli, and the like.

Confectionery products, such as marshmallows, sprinkles, chocolate, and the like.

Meat products such as processed meat products, beef, pork, chicken, lamb, and the like.

Seafood products such as, for example, fish, shell fish, and the like.

Non-limiting examples of dessert products include cakes, muffins, pastries, and the like.

Beverages such as, for example, chocolate milk, tea, coffee, and the like.

Non-limiting examples of condiments include ketchup, mustard, hot sauce, mayonnaise, salt, pepper, and the like.

Foods containing lactose are, for example, milk, low-fat milk, skim milk, chocolate milk, buttermilk, sweetened condensed milk, dried whole milk, instant nonfat dry milk, evaporated milk, low-fat yoghurts, frozen yoghurts, ice cream, ice milk, sherbet, cheese, cottage cheese, low-fat cottage cheese, cream, sour cream and butter. Other foods that may contain hidden lactose are: nondairy creamers, powdered artificial sweeteners, foods containing milk powder or nonfat milk solids, bread, cake, margarine, creamed soups, pancakes, waffles, processed breakfast cereals, salad dressings, lunch meats, puddings, custards, confections and some meat products.

In a preferred embodiment, the food product is a cereal coated with β-galactosidase. Inclusions, such as, for example, raisins, strawberries, bananas, nuts, berries, marshmallows, and mixtures thereof may be included in the cereal. Optionally, the inclusions may be treated with a lactose cleaving enzyme.

The food product treated with the lactose cleaving enzyme is useful for ameliorating the symptoms of lactose intolerance in an individual who suffers from lactose intolerance. It may be used in a method, where a non-lactose containing product treated with a lactose cleaving enzyme is provided to an individual who suffers from lactose intolerance, and the individual consumes concomitantly the non-lactose containing product treated with the lactose cleaving enzyme with a lactose containing product.

Unless otherwise defined, all technical and scientific terms used herein have the same meaning as commonly understood by one of ordinary skill in the art to which this invention pertains. The materials, methods, and examples described herein are illustrative only and not intended to be limiting.

One particularly valuable aspect of the invention is how lactase dosing and lactose ingestion are tied. An important issue with using lactase enzyme supplements is the importance of timing. If the lactase is taken too far before a lactose containing meal the enzyme may not still be active or may not be at the correct location in the GI track to hydrolyze the enzyme. If it is taken too late, the lactose may arrive in the colon before being hydrolyzed. Long meals may require multiple doses to be effective. Despite supplement usage instructions which state “Take with the first bite,” many users find this in-opportune and significant gastro-intestinal distress ensues. With this invention the problem is corrected. For example, with each bite of ice cream the cone provides some lactase. Assuring the timing is correct greatly enhances the net efficacy of lactase use.

### EXAMPLE 1

10 kg of beta-galactosidase (Lactase F “Amano” 100Conc-K, Amano Enzyme Inc, 2-7, 1 chome, Niahiki, Nagoya, Aichi 460-8630, Japan) is mixed and thoroughly dissolved in 90 kg of de-ionized water at 25° C.

1 kg of this solution is sprayed on 112 kg of cereal (Corn Flakes) and air dried at 30° C. The resulting cereal contains about 3000 FCC lactase units (about 25 mg) per 28 g serving.

### EXAMPLE 2

28 grams of cereal from Example 1 is mixed with ½ cup of 2% fat milk and consumed by a lactose intolerant individual.

### EXAMPLE 3

50 kg of beta-galactosidase (Lactase F “Amano” 100Conc-K, Amano Enzyme Inc, 2-7, 1 chome, Niahiki, Nagoya, Aichi 460-8630, Japan) is mixed and suspended in 50 kg of de-ionized water at 25° C.

1 kg of this suspension is sprayed on 112 kg of cereal (Corn Flakes) and allowed to dry at room temperature. The resulting cereal contains about 1500 FCC lactase units (about 12.5 mg) of lactase per 28 gram serving.

### EXAMPLE 4

Aspergillus oryzae enzyme in solution equal to about 2000 to about 3000 FCC lactase units (about 25 mg) is sprayed onto about one cup of commercially prepared wheat-based cereal and flash dried cereal at less than 60° C.

### EXAMPLE 5

The inside of one Joy Sugar Cone #310 (Joy Cone Company, Hermitage Pa.) is spray coated with an aqueous solution of Aspergillus oryzae enzyme to equal 6000-9000 FCC lactase units. The treated cone is then subjected to freeze drying.

### EXAMPLE 6

Pizza dough is formed and baked. The resulting pizza crust is sprayed to coat one side with Aspergillus oryzae enzyme 6000-9000 FCC lactase units, then flash dried. The lactase units per 10-inch diameter plated crust equal 60,000 FCC lactase units, translating into 6,000-7,000 FCC units per serving noting 8-10 servings per crust.

### EXAMPLE 7

A dry blended product made with milk solids, maltodextrin, a sweetener, an emulsifier, an alkalized unsweetened cocoa and/or additional flavoring ingredients is formed. The particles of the dry mix are bonded together through the introduction of a carrier to an extent sufficient to make their surfaces adhesive. The carrier includes lactase enzyme. The mixture is subsequently heat treated to form a dry material suitable for dispersibility in milk.

### EXAMPLE 8

Raisins are coated by placing them into a heated tumble drum/panner and pumping a ratioed amount of lactase enzyme in a liquid carrier into the drum/panner in an amount sufficient to coat the raisins. The drum continues rotating while the liquid evaporates from the raisins, leaving behind the lactase enzyme. The lactase enzyme in the liquid carrier is about 190,000 FCC-300,000 FCC per pound of raisins.

The process is repeated using nuts and/or almonds. 90,000 FCC to 150,000 FCC per pound of lactase enzyme is applied per pound of nuts and/or almonds.

While the invention has been described above with reference to specific embodiments thereof, it is apparent that many changes, modifications, and variations can be made without departing from the inventive concept disclosed herein. Accordingly, it is intended to embrace all such changes, modifications, and variations that fall within the spirit and broad scope of the appended claims. All patent applications, patents, and other publications cited herein are incorporated by reference in their entirety.

What is claimed is:

1. A non-lactose containing food product treated with a lactose cleaving enzyme.

2. The product of claim 1, wherein the lactose cleaving enzyme is β-galactosidase.

3. The product of claim 2, wherein the β-galactosidase is lactase.

4. The product of claim 1, wherein the lactose cleaving enzyme is isolated and purified.

5. The product of claim 1, wherein the food product is treated with an effective amount of the lactose cleaving enzyme.

6. The product of claim 1, wherein the treatment involves applying a coating composition to the food product, wherein the coating composition includes the lactose cleaving enzyme.

7. The product of claim 6, wherein the coating composition includes at least about 500 FCC lactase units per serving size of the food product based on a serving size.

8. The product of claim 6, wherein the coating composition substantially surrounds the food product.

9. The product of claim 6 wherein the coating composition substantially covers at least one surface of the food product.

10. The product of claim 1, wherein the product is selected from the group consisting of grain products, snack products, vegetable products, fruit products, confectionery products, meat products, seafood products, dessert products, beverage products, condiments, and mixtures thereof.

11. A food product comprising a lactose cleaving enzyme treated product and a lactose-containing product.

12. The product of claim 11, wherein the lactose cleaving enzyme treated product is a grain product selected from the group consisting of wheat, rice, rye, corn, barley, oats, flax, millet, buckwheat, spelt, quinoa, amaranth, soy, and mixtures thereof.

13. The product of claim 11, wherein the lactose-containing product is selected from the group consisting of milk, ice cream, cream, cheese, sour cream, yoghurt, and mixtures thereof.

14. A method of ameliorating the symptoms of lactose intolerance in an individual who suffers from lactose intolerance, comprising the steps of:
(a) providing a non-lactose containing product treated with a lactose cleaving enzyme; and
(b) consuming concomitantly the non-lactose containing product treated with a lactose cleaving enzyme with a lactose containing product.

15. The method of claim 14, wherein the lactose cleaving enzyme is β-galactosidase.

16. The method of claim 14, wherein the lactose cleaving enzyme is isolated and purified.
